(19) United States
(12) Patent Application Publication
(10) Pub. No.: US 2023/0407951 A1
(43) Pub. Date: Dec. 21, 2023

(54) Transfer device for a continuous rotary motion

(71) Applicant: FNF INNOVATION SH.P.K., Gjilan (XK)

(72) Inventor: Fehmi Mustafa, Gjilan (XK)

(21) Appl. No.: 18/241,309

(22) Filed: Sep. 1, 2023

Related U.S. Application Data
(63) Continuation-in-part of application No. PCT/CH2022/050010, filed on Nov. 28, 2022.
Application No. PCT/CH2022/050010 is a continuation-in-part of application No. PCT/CH2021/050008, filed on Jun. 17, 2021.

(51) Int. Cl. F16H 21/48; B62M 15/00; F03D 15/00

(52) U.S. Cl. CPC F16H 21/48; B62M 15/00; F03D 15/00; F05B 2260/40

(57) ABSTRACT

The present invention relates to a device for transferring a continuous rotary motion, characterized in that said device comprises one crankshaft unit (4, 14) at each of the two ends thereof, said units each comprising one crankshaft (5, 15) having at least three crank offsets (1, 2, 3, 11, 12, 13) distributed uniformly about the axis of the corresponding crankshaft (5, 15) with respect to the angular range from 0° to 360°, wherein the crankpins of opposing crank offsets (1, 11, 2, 12, 3, 13) of the crankshafts (5, 15) of the two crankshaft units (4, 14) are connected to each other by a rope or cable (8, 9, 10), and to the use of such a device for transferring a rotary motion in a bicycle or in a wind power plant.

### CROSS-REFERENCE TO RELATED APPLICATIONS

This application is a continuation-in-part of PCT Application No. PCT/CH2022/050010, filed Nov. 28, 2022, and is also a continuation-in-part of PCT Application No. PCT/CH2021/050008, filed Jun. 17, 2021.

### BACKGROUND

The present invention relates to a transfer device for a continuous rotary motion.

Various rotary motion transfer devices exist, such as devices having ropes, belts, chains, etc.

### BRIEF DESCRIPTION

The present invention is a more advanced alternative to said typical transfer devices avoiding the disadvantages of the known devices, such as winding or twisting of the transfer medium, having a negative effect on the function thereof. The objects of the invention include reducing cost and structurally improving such devices.

### BRIEF DESCRIPTION OF THE DRAWINGS

FIG. 1A is a view of a device for transferring a continuous rotary motion.

FIG. 1B is a view showing the angular offset of three crank offsets.

FIG. 2 is an image of a bicycle in which the device can be used.

FIG. 3 is a first image of a wind power plant in which the device can be used.

FIG. 4 is a second image of a wind power plant in which the device can be used.

### DETAILED DESCRIPTION

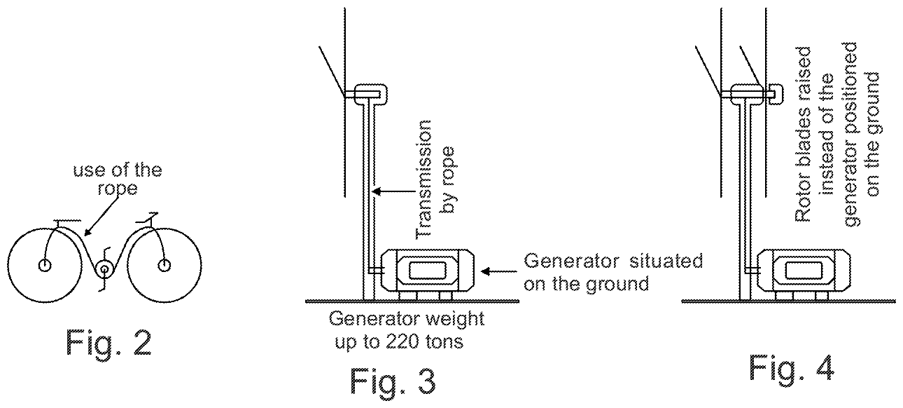

The device according to the invention provides particular advantages for various applications, such as in bicycles (FIG. 2), wind power plants (FIGS. 3 and 4), and wherever robust transferring of rotary motions by means of cables or ropes is possible or necessary. Furthermore, the device according to the invention is durable and easily produced.

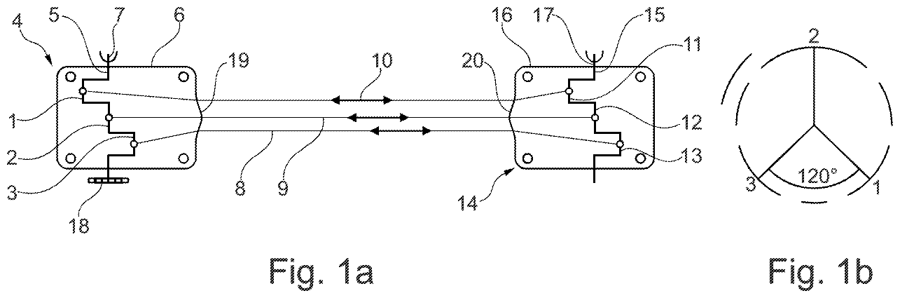

The functional principle of the device according to the invention is evident from FIG. 1.

The present invention accordingly provides a device for transferring a continuous rotary motion, characterized in that said device comprises one crankshaft unit at each of the two ends thereof, said units each comprising one crankshaft 10 having at least three crank offsets distributed uniformly about the axis of the corresponding crankshaft with respect to the angular range from 0° to 360°, wherein the crankpins of opposing crank offsets of the crankshafts of the two crankshaft units are connected to each other by a rope or cable.

The device according to the invention for transferring a continuous rotary motion comprises a relatively simple structure and provides advantages with respect to durability, friction, cost, and precision.

As is further evident from the schematic sketch of FIG. 1, the device according to the invention can be used for transferring a continuous rotary motion in both rotary directions, that is, clockwise and counterclockwise, and both from the first to the second crankshaft unit and from the second to the first.

The device according to the invention is characterized by the particular manner for transferring the forces causing the rotary motion, namely by tensile forces transferred from the crankpins of the first crankshaft to the connecting rope/cable and from the same to the crankpins of the second crankshaft.

Rotary motions can thus be transferred from a first to a second crankshaft unit on a straight path, but also on a curved path, depending on how the ropes/cables transferring the force are guided between the crankshaft units.

By avoiding friction between the ropes/cables for the device according to the invention, the ropes/cables need not be wound, twisted, or sheathed in order to optimally utilize the tensile force of the rope, as is a disadvantage of previous methods, so that the transferring of rotary motion can be implemented continuously and with high efficiency.

The device according to the invention is described in more detail using the embodiment shown in FIG. 1a).

The device comprises a first crankshaft unit 4 and a second crankshaft unit 14 comprising a first 6 and second 16 housing in which a first crankshaft 5 and a second crankshaft 15 are rotatably supported 7, 17. The crankshafts each comprise three crank offsets 1, 2, 3 and 11, 12, 13, each disposed at an angular spacing of 120° relative to each other about the axes of rotation of the crankshafts, as shown in FIG. 1b), that is, at positions 0°, 120°, and 240° relative to the angular range from 0 to 360° about the crankshaft axis.

The crankpins of the crank offsets 1, 2, 3 of the first crankshaft 5 are each connected to the opposing crankpins of the crank offsets 11, 12, 13 of the second crankshaft 15 by ropes or cables 8, 9, 10. For example, the crankpin of the crank offset 1 of the first crankshaft 5 is connected to the crank offset 11 of the second crankshaft 15 by the rope/cable 8. The ends of the ropes/cables are thereby each disposed rotatably about the crankpins and attached to the same.

One outlet 19, 20 each for the ropes/cables 8, 9, 10 is present on the sides of the housing 6, 16 facing toward each other.

During operation, the first crankshaft 5 is caused to rotate by means of a gear 18 connected to the axis of the first crankshaft, for example, whereby ropes/cables 8, 9, and 10 successively transfer the rotary motion to the second crankshaft 15 by means of tensile forces for a counterclockwise rotation, for example, whereby said second crankshaft is caused to rotate in the same direction.

As shown in FIG. 2, the device according to the invention can be used, for example, in a bicycle for transferring the rotary motion of the pedal cranks into the rotary motion of the driven wheel, or, as shown in FIGS. 3 and 4, in a wind power plant for transferring the rotary motion from the rotor unit to the power generating unit present on the ground.

1. A device for transferring a continuous rotary motion, characterized in that said device comprises one crankshaft unit (4, 14) at each of the two ends thereof, said units each comprising one crankshaft (5, 15) having at least three crank offsets (1, 2, 3, 11, 12, 13) distributed uniformly about the axis of the corresponding crankshaft (5, 15) with respect to the angular range from 0° to 360°, wherein the crankpins of opposing crank offsets (1, 11, 2, 12, 3, 13) of the crankshafts (5, 15) of the two crankshaft units (4, 14) are connected to each other by a rope or cable (8, 9, 10).

2. The device according to claim 1, characterized in that the crankshafts (5, 6) each comprise 3 crank offsets (1, 2, 3 or 11, 12, 13), each disposed at an angular spacing of 120° relative to each other about the axis of rotation of the crankshafts (5, 6).

3. The device according claim 2, characterized in that the ropes or cables (8, 9, 10) are rotatably attached about the crankpins.

4. The device according claim 3, characterized in that the crankshaft units (4, 14) each comprise a housing (6, 16) in each of which the associated crankshaft (5, 15) is supported.

5. The device according claim 4, characterized in that said device is combined with another conversion system.

6. The device according to claim 1, characterized in that the ropes or cables (8, 9, 10) are rotatably attached about the crankpins.

7. The device according to claim 1, characterized in that the crankshaft units (4, 14) each comprise a housing (6, 16) in each of which the associated crankshaft (5, is supported.

8. A method for transferring a rotary motion in a bicycle or in a wind power plant, comprising using the device of claim 1 in the bicycle or the wind power plant.
